(19) United States
(12) Patent Application Publication
(10) Pub. No.: US 2006/0047955 A1
(43) Pub. Date: Mar. 2, 2006

(54) Application code integrity check during virtual machine runtime

(75) Inventors: Sylvain Prevost, Austin, TX (US); Kapil Sachdeva, Austin, TX (US)

Correspondence Address: ANDERSON & JANSSON L.L.P., 9501 N. CAPITAL OF TX HWY #202, AUSTIN, TX, 78759, US

(73) Assignee: Axalto Inc., Austin, TX (US)

(21) Appl. No.: 10/929,221

(22) Filed: Aug. 30, 2004

(51) Int. Cl. H04L 9/00

(52) U.S. Cl. 713/165

(57) ABSTRACT

Protecting an application of a multi-application smart card against unauthorized manipulations. A system and method for guarding against unauthorized modifications includes partitioning the application into a plurality of basic blocks. Basic blocks are programming atomic units that have one entry point and one exit point and comprises a set of data units. For each basic block a check value associated with a basic block is computed wherein the check value is a function of the data units of the basic block. This check value is some how remembered and later recalled and checked either during execution of the corresponding basic block of the application program or prior to execution of the application program. During or prior to execution of the basic block the re-computed check value is verified to be the same as the remembered check value. If not, an error condition is indicated and a corrective action may be taken.

### BACKGROUND OF THE INVENTION

1.0 Field of the Invention

The present invention relates generally to verification of the integrity of computer programs during run-time and more particularly to verification that a smart card application program has not been manipulated after the application program has been loaded.

2.0 Description of the Related Art

Smart cards are small personal computing devices that are used to protect very sensitive information. Smart cards may be used to perform banking functions, provide access to health records, personalization of computer network access, secure building access, and many more functions. Smart cards are also used as subscriber identity modules (SIM) in certain mobile telephony networks.

A crucial selling point of smart cards is the security of the data stored thereon or accessed through the use of smart cards. In many circumstances smart cards provide heightened levels of security than other security mechanisms because smart cards include a combination of security features. For example, to gain access to some data you need to know a password stored on the smart card and you must be in possession of the smart card.

A recent trend in smart card technology is so called multi-application smart cards. These cards may be programmed with multiple disjointed application programs. For example, the same card may be used to access both banking records as well as provide health care information. Examples of such cards include the Cyberflex family of cards from Axalto Inc.

A common feature of multi-application smart cards is that the application programs may be loaded onto the smart card after the card has been issued by the manufacturer or even after an end-user has taken possession of the card. Each such application program in a multi-application smart card is stored in some form of programmable memory on the smart card.

Such post-manufacture programmability of smart cards provide increased flexibility and power of use of the smart cards. However, the price for that flexibility and power is vulnerability to program manipulation. Because the application programs are stored on the smart card in programmable memory, there is a risk that the programs are manipulated with. Furthermore, because the application programs may be loaded from sources where they have been manipulated with prior to loading onto a smart card, there is a risk that even when first loaded onto a smart card, the program has been corrupted in some fashion.

The risks of such manipulations are numerous. It is conceivable that a program that otherwise appears to behave as expected, issues unauthorized transactions or reveals private information to unauthorized persons. Other modifications can simply result in incorrect computations or other undesirable behavior.

As noted, modification to application programs may be from intentional malicious actions on the part of someone intent on defeating security mechanisms of the smart card. However, modifications may also occur from some type of hardware or software failure that is entirely unintentional. It is desirable to guard against both intentional and inadvertent modifications to application programs.

Hitherto, un-authorized manipulation of smart card application programs have been avoided by techniques that are employed during the loading of the application programs onto the smart card such as using the DAP mechanism of GlobalPlatform, on-card byte code verification, or performing checksum calculations. The DAP mechanism is described in The GlobalPlatform Card Specification, version 2.1, issued June 2001, obtainable from www.globalplatform.org and an on-card byte code verifier is described in Java bytecode verification on Java cards, Roberto Barbuti, Stefano Cataudella, Proceedings of the 2004 ACM symposium on Applied Computing, Pages: 431-438, 2004, ISBN:1-58113-812-1.

A problem with the known prior art application program verification schemes is that these schemes do not catch malicious modifications made to application programs after the programs have been loaded onto a smart card. Therefore, there is a continuing need to perform integrity checking of smart card application programs during run-time. Accordingly, from the foregoing it is apparent that there is a hitherto unresolved need for a system and methodology for verifying integrity of smart card programs during run-time.

### SUMMARY OF THE INVENTION

In a preferred embodiment, a system and method according to the invention guard against unauthorized manipulation or unintentional modification of an application program of a multi-application smart card by partitioning the application into a plurality of basic blocks, wherein each basic block has one entry point and one exit point and comprises a set of data units, computing a check value associated with a basic block wherein the check value is a function of the data units of the basic block, remembering the corresponding check value, recomputing the check value either during runtime execution of the application program or prior to execution of the application program, and verifying that the re-computed check value is the same as the remembered check value.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a smart card according to the invention may be used to provide secure computing services.

FIG. 2 is a schematic illustration of an exemplary architecture of a resource-constrained device.

FIG. 3 is a schematic illustration of a software architecture for a resource-constrained device.

FIG. 4 is a flow-chart illustrating the operation of a method or system according to the invention to verify the integrity of application programs during the run-time of the application program.

FIG. 5 is a flow-chart illustrating an alternative embodiment of the invention in which the integrity of application programs is verified prior to the execution of the application program.

### DETAILED DESCRIPTION OF THE INVENTION

In the following detailed description and in the several figures of the drawings, like elements are identified with like reference numerals.

As shown in the drawings for purposes of illustration, the invention is embodied in a system and method for guarding application programs, particularly those loaded onto resource-constrained devices such as smart cards, against unauthorized manipulation or modification. Unauthorized manipulation or modification may originate from intentional malicious conduct of someone intent on manipulating a program to perform some unauthorized task. However, modifications to programs may occur from unintentional causes such as hardware or software failures. The system and method according to the invention uses the computer programming concept of basic blocks to verify the integrity of computer programs during execution to detect modifications to application programs whether intentional or unintentional.

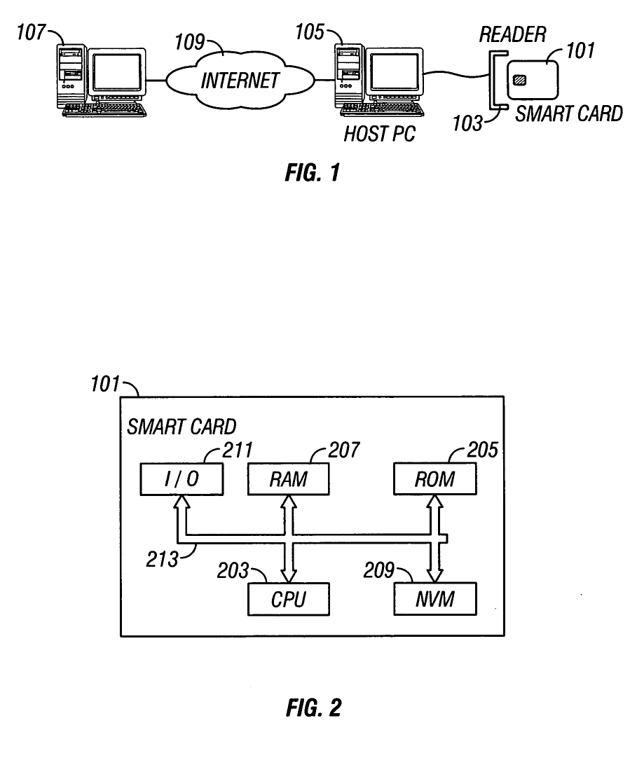

FIG. 1 is a schematic illustration of the operating environment in which a resource-constrained device according to the invention may be used to provide secure communication with a remote entity. A resource-constrained device 101, for example, a smart card, is connected to a computer network 109, for example, the Internet. The resource-constrained device 101 may be connected to the computer network 109 via a personal computer 105 that has attached thereto a card reader 103 for accepting a smart card. However, the resource-constrained device 101 may be connected in a myriad of other ways to the computer network 104, for example, via wireless communication networks, smart card hubs, or directly to the computer network 109. The remote node 105 is a computer system of some sort capable to implement some functionality that may either seek access to information on the smart card 101 or to which the smart card user may seek access. For example, the remote node 107 may be executing a banking software that a user of the smart card 101 is seeking to obtain access to. The smart card 101 may then provide some access control functionality or may even be an electronic purse to which funds are downloaded from the remote computer.

The scenario of FIG. 1 is presented here merely for the purpose of providing an example and must not be taken to limit the scope of the invention whatsover. Only the imagination of designers limits the myriad of possible deployment scenarios and uses for smart cards.

FIG. 2 is a schematic illustration of an exemplary architecture of a resource-constrained device 101. The resource-constrained device 101, e.g., a smart card has a central processing unit 203, a read-only memory (ROM) 205, a random access memory (RAM) 207, a non-volatile memory (NVM) 209, and a communications interface 211 for receiving input and placing output to a device, e.g., the card reader 102, to which the resource-constrained device 101 is connected. These various components are connected to-one another, for example, by bus 213. In one embodiment of the invention, the SSL/TLS module 103, as well as other software modules shown in FIG. 1, would be stored on the resource-constrained device 101 in the ROM 206. During operation, the CPU 203 operates according to instructions in the various software modules stored in the ROM 205.

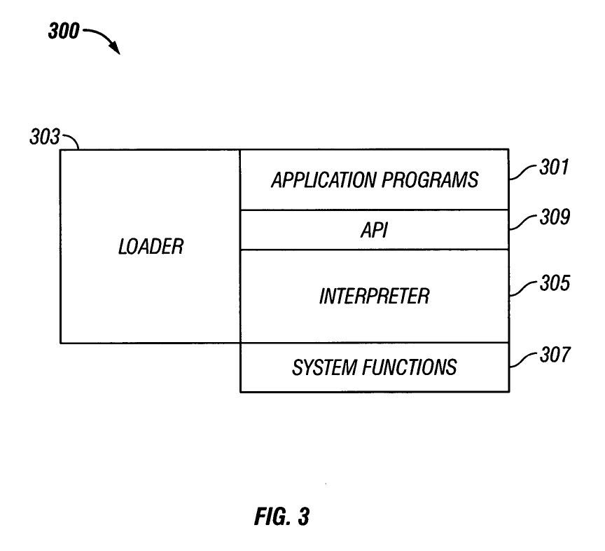

FIG. 3 is a block diagram of an exemplary software architecture 300 that one may find implemented on a smart card 101. The software architecture 300 includes several application programs 301. These are loaded onto the smart card by a loader 303. The application programs 301 would typically be loaded into the non-volatile memory 209. However, in other scenarios an application program may be permanently written onto the smart card at manufacture by having it stored in the ROM 205. If the smart card 101 is called upon to execute a program for only one session, it would be possible to have the program loaded in the RAM 207. However, that would be a rare circumstance. On the other hand, during execution of an application program, it is indeed possible that certain portions of the application program is loaded into the RAM 207.

In this example, several application programs 301 are executed by the CPU 203 under the control of instructions of an interpreter 305. The interpreter 303 may, for example, be a Javacard Virtual Machine as found on the Cyberflex smart card family from Axalto Inc. or the interpreter of a smart card implementing a .NET CLI (Common Language Infrastructure) as found in the .NET smart card technology from Axalto Inc. (www.axalto.com/infosec/NET_faq.asp). In alternative embodiments, the application programs 301 are compiled into executable code and do not require further interpretation by the interpreter 305. However, in such embodiments, the job control would be managed by some operating system program that would take the place of the interpreter 303.

The interpreter 303 is usually a static component of a smart card 101 and would therefore be loaded into the ROM 205. The interpreter 303 may also be burned into some form of firmware. In another alternative the interpreter 303 may be stored in the non-volatile memory 209.

In most embodiments of the invention, the smart card software architecture 300 also includes some system functions 307. System functions 307 may include security functionality, cryptography functionality, and utility libraries that may be called by application programs 301.

The application programs 301 may access functions provided by the smart card system software 307 by issuing calls through an application program interface 309.

One possible breach of security provided by a smart 101 is the manipulation of the application programs 301 to perform some function other than or additional to that for which a give program was designed. Such manipulations could be either intentional so as to provide a maliciously intending party access to some information for which she is not authorized. Alternatively, the manipulations could be purely accidentally caused by a failure of the smart card hardware or software. In either case, it is desirable to detect any modifications made to the application programs. It is desirable that such detection be performed during the execution of an application program by the interpreter 305.

The present invention presents a solution for detecting modifications of application programs during interpreter runtime by breaking an application program into basic blocks and performing integrity checks on the basic blocks.

A basic block is a sequence of instructions without any branches in or out of the sequence. Another way to define a basic block is that it is a sequence of instructions in which the instructions are executed in the order they appear in the program. A basic block may begin with procedure entry points, fall-through statements following conditional statements. Basic blocks terminate at branch statements and conditional statements. Basic blocks are described in Alfred V. Aho, Ravi Sethi, Jeffrey D. Ullman, Compilers—Principles Techniques and Tools. Addison-Wesley 1988, ISBN 0-201-10088-6.

Consider the following example code:

TABLE 1
Example Code Illustrating Basic Blocks

1 RadiusArray = [1,2,3,5,10]
2 PI = 3.14159
3 ArraySize = 5
4 MaxSphereSize = 600
5 For I = 1, ArraySize
6 {
7 Radius = RadiusArray[i]
8 CircleArea = PI * R**2
9 CircleCircumference = PI * R * 2
10 SphereVolume = 4/3 * PI * R **3
11 IF SphereVolume > MaxSphereSize Then
12 {
13 R = 8
14 SphereVolume = 4/3 * PI R**3
15 Write (’Radius Reset to 8’)
16 }
17 ELSE
18 {
19 Write (’Radius OK’)
20 }
21 WRITE (R, CircleArea, CircleCircumference,
SphereVolume)
22 }

In the code segment of Table 1, several basic blocks may be identified, for example, the instructions of lines 1-4, the instructions of lines 7-10, the instructions of lines 13-15, line 19, and line 21 are each basic blocks, respectively.

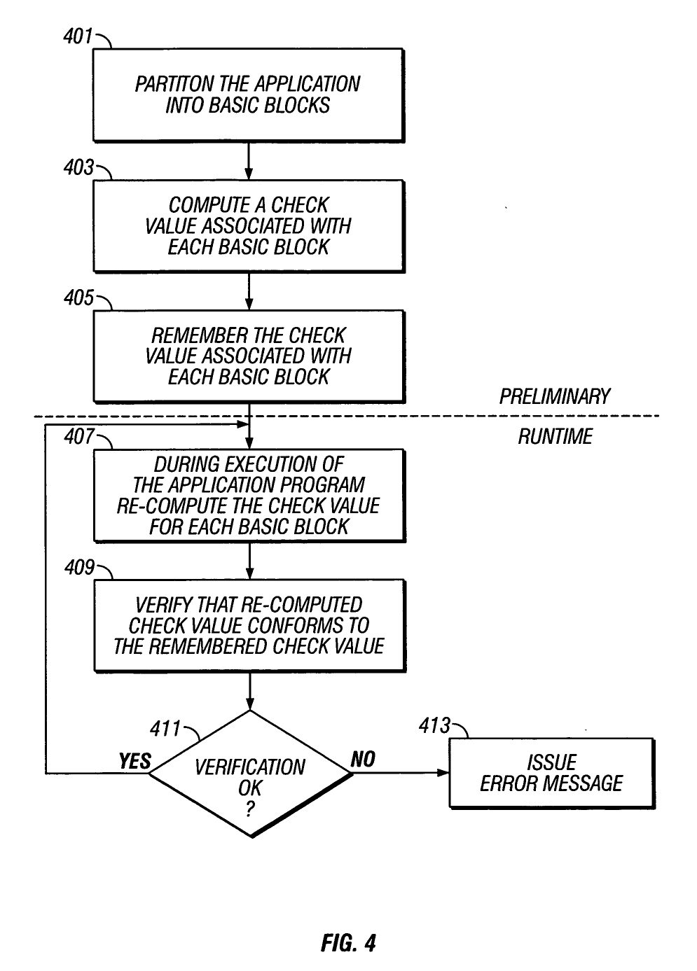

FIG. 4 is a flow-chart illustrating the use of basic blocks to verify the integrity of a program 301 during the execution of the program 301 by the interpreter 305.

An application program 301 is first partitioned into a plurality of basic blocks, step 401. The partitioning step may be performed as part of the compilation or conversion of the program 301 and thus be performed off-card prior to loading the application program 301 onto the smart card 101. Alternatively, the partitioning step is performed by the loader 303 in conjunction with the loading of the application program 301 onto the smart card 101.

For each basic block of the application program 301 a check value is computed for that basic block, 403. The check value should ideally be a unique number that is a function of all the elements that make up the basic block. Examples, of check value computations include checksum computations. In alternative embodiments, a digest of the components of the basic block may be computed by, for example, the MD5 or SHA-1 algorithms. MD5 and SHA-1 are two different algorithms that may be used for determining a condensed fixed length representation of a message. This representation is known as a digest. MD5 is described in “The MD5 Message-Digest Algorithm”, IETF Network Working Group RFC 1321, by R. Riverst, which is incorporated herein by reference. SHA-1 is described in “US Secure Hash Algorithm 1 (SHA1)”, IETF Network Working Group RFC 3174, by D. Eastlake, and P. Jones, which is incorporated herein by reference.

In an alternative embodiment, check values are not computed for all basic blocks but only a subset of the basic blocks that make up an application program 301. This could be done by either selecting for integrity check only those basic blocks that are particularly prone to modification or the selection of basic blocks for verification could be made on an entirely random basis. Alternatively, the selection of basic blocks for verification according to the method of the invention may be in response to a security level parameter. If the security level is set low, no basic blocks are verified. On the other hand, if the security level is set at its highest allowable level, all basic blocks are verified. Security levels between these values would cause some subset of basic blocks to be verified.

When the check values for the basic blocks have been computed by step 403 these check values are somehow remembered, step 405. The remembering step may be accomplished, for example, by storing the check values in a one-to-one mapped table indexed by an identifying number for each basic block. Other examples include appending the code for each basic block with the check value associated with the basic block.

Steps 401, 402 and 403 have been described herein above as if these steps are each performed on the entire application program and then followed by the next step in sequence. However, that is merely one possible program flow. In an alternative, the steps of computing a check value for a basic block is performed after a basic block has been identified and then the check value stored for that basic block. Indeed, such an architecture may be preferred.

The steps 401 through 403 are performed as a preliminary operation to compute check values that are later used to verify the integrity of an application program during interpreter runtime. During runtime the interpreter 305 (or some other system function) causes the CPU 203 to re-compute the check values as each basic block is being executed, step 407. After the check value has been re-computed, the re-computed check value is compared against the remembered check value, step 409. If the check values are stored in a table with a mapping of basic blocks against check values, the step 409 includes the sub-step of retrieving the remembered check value for the basic block from that table.

If the verification step confirms that the re-computed and remembered check values match, step 411, the execution of the program continues and steps 407 and 409 are performed on the next basic block that is to be executed. On the other hand, if the verification step fails, step 411, an error message or a warning message may be issued, step 413, and some corrective action, e.g., termination of the application program 301 or confiscation of the smart card 101 may be executed.

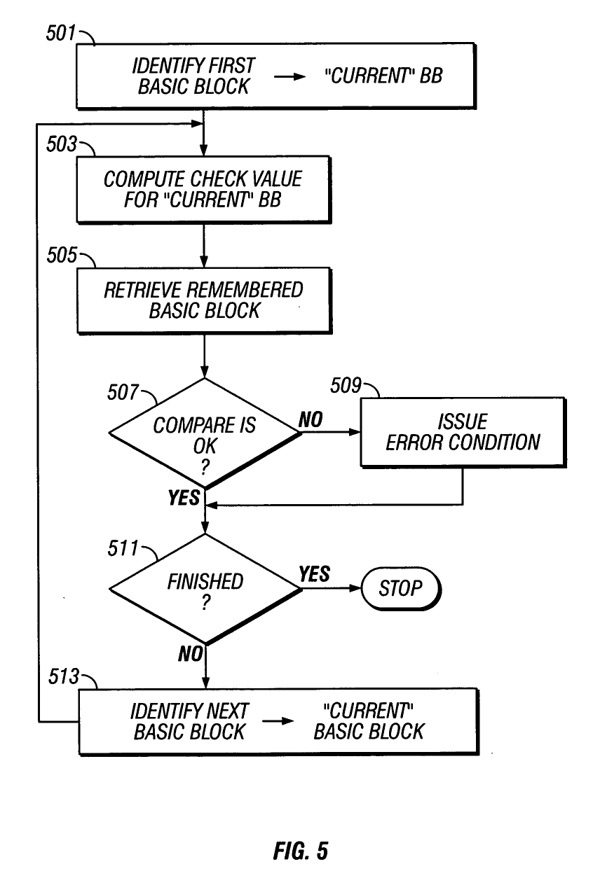

In an alternative embodiment, illustrated in the flow chart of FIG. 5, prior to executing an application program, the interpreter 305 determines all basic blocks of an application program 301 (The interpreter 305 may do that by first determining the “first” basic block assigning that basic block to a pointer “current” basic block, step 501. On subsequent loops the interpreter 305 would identify the “next” basic block, step ). For each basic block (the “current” basic block), the interpreter 305 computes the check value associated with that basic block, step 503, retrieves the remembered check value for that basic block, step 505, and compares the check value against the remembered check value, step 507. If the computed check value does correspond to the remembered check value, which would indicate some form of modification, step 507, the interpreter issues an error or warning condition, step 509. In some embodiments the interpreter may terminate the checking at that point.

Otherwise, the checking continues until all basic blocks have been verified, step 511, by determining the next basic block, step 513, and repeating steps 503 through 513 until the entire program 301 has been verified.

As discussed above, in some alternatives, not all basic blocks are verified.

In one embodiment of the invention, the application programs are originally written in the C# programming language or the JAVA programming language. Programming of application programs in Java and loading such programs onto smart cards is described in U.S. Pat. No. 6,308,317, issued to Timothy J. Wilkinson, et al. on Oct. 23, 2001 and entitled Using a high level programming language with a microcontroller, the entire disclosure of which is incorporated herein by reference. The application programs are first converted from a compiled form into a binary form suitable for loading onto the smart card 101. One example of such files include Converted Applet (CAP) files. CAP files are described in Java Card Platform Specification. v2.1. http://java.sun.com/products/javacard/specs.html. In one embodiment of the invention, the check values for the basic blocks of a CAP file is appended as a data structure of the CAP file.

Although specific embodiments of the invention has been described and illustrated, the invention is not to be limited to the specific forms or arrangements of parts so described and illustrated. For example, the invention, while described in the context of smart cards for illustrative purposes, is applicable to other computing devices. The invention is limited only by the claims.

We claim:

1. A method of protecting an application of a multi-application smart card against unauthorized manipulations, comprising:
partitioning the application into a plurality of basic blocks, wherein each basic block has one entry point and one exit point and comprises a set of data units;
computing a check value associated with a basic block wherein the check value is a function of the data units of the basic block;
remembering the corresponding check value;
verifying that the re-computed check value is the same as the remembered check value.

2. The method of claim 1, further comprising:
repeating the steps of computing a check value and remembering the check value for each of a plurality of basic blocks;
repeating the step of re-computing the check value for each of the plurality of basic blocks.

3. The method of claim 1, wherein the check value is a checksum.

4. The method of claim 1, wherein the check value is a digest computed using MD5 or SHA-1.

5. The method of claim 1, wherein the check value is remembered by storing the check value in a data structure appended to the application.

6. The method of claim 1, wherein the application is a CAP file.

7. The method of claim 6, wherein the data structure is a custom component appended to the CAP file.

8. The method of claim 1, further comprising terminating execution of the application in response to failure of the verifying step.

9. The method of claim 1, wherein the verification step is performed in conjunction with the execution of the program.

10. The method of claim 1, wherein the verification step is performed prior to executing the program.

11. The method of claim 2, wherein the verification step of a particular basic block is performed in conjunction with the execution of that particular basic block.

12. The method of claim 2, further comprising:
defining a protection level for a program;
verifying the plurality of basic blocks according to a policy associated with the protection level for a program.

13. The method of claim 12, wherein the protection level is selected from protection levels associated with policies selected from the set including examining the check value for each basic block, examining the check value for selected basic blocks, examining the check value for each basic block on an initial execution of the basic block, examining the check value for each basic block on every execution of the each basic block.

14. The method of claim 1, further comprising:
loading the application onto the smart card from an external device;
linking the application on the smart card; and
wherein the step of computing the check value is performed after the linking step.

15. The method of claim 14, comprising operating an operating system program on the smart card to perform the step of computing the check value.

16. The method of claim 14, comprising operating an operating system program on the smart card to perform the step of verifying the check value.

17. A method of verifying that a program has not been manipulated with subsequent to loading the program onto a computer, comprising:
dividing the program into a plurality of basic blocks wherein each basic block has one entry and one exit;
computing a check value from the data that make up the basic block;
remembering the check value in a data structure of the program;
while executing the program:
recomputing the check value;
verifying that the recomputed check value conforms to the remembered check value;
rejecting execution of the program if the verification step fails.

18. The method of claim 17, wherein the check value is computed using a cyclic redundancy check.

19. The method of claim 17,wherein the check value is computed by computing a digest of the basic block.

20. The method of claim 19 wherein the digest is computed using an method selected from MD5 and SHA-1.

21. The method of claim 17,wherein the data structure is a table appended to the program.

22. A multi-application smart card in which an application may be verified to confirm that the application has not been tampered with subsequent to loading and linking the application onto the smart card, comprising:
at least one application program loaded onto the smart card;
a first logic for managing the execution of the application program;
a second logic for identifying a basic block of the application program;
a third logic for computing a check value based on data that make up the basic block;
a fourth logic for remembering the check value;
a fifth logic for verifying at some later time that the check value is the same as the check value computed by the third logic.

23. The multi-application smart card of claim 22, wherein the first logic means is a virtual machine operable to interpret the application.

24. The multi-application smart card of claim 22, wherein the fourth logic comprises a logic means for creating a data structure to remember the check value and for appending the data structure to the application.

25. The multi-application smart card of claim 22, comprising an operating system comprising the fifth logic means.

26. The multi-application smart card of claim 22, wherein the second logic means is operable to determine a plurality of basic blocks of the program; wherein the third logic means is operable to compute the check value of a plurality of basic blocks of the program; wherein the fourth logic means is operable to remember the check value of a plurality of the basic blocks of the program; and the fifth logic means is operable to verify a plurality of the check values according to a security policy.

27. The multi-application smart card of claim 26, wherein the security policy is selected from the set including verifying each basic block on each execution, verifying a subset of the basic blocks on each execution.
